(19) United States
(12) Patent Application Publication
(10) Pub. No.: US 2008/0315000 A1
(43) Pub. Date: Dec. 25, 2008

(54) Integrated Controller And Fault Indicator For Heating And Cooling Systems

(76) Inventors: Ravi Gorthala, Asheville, NC (US); Ron Gumina, Mandeville, LA (US)

Correspondence Address: PAUL LORDEN GRIFFITHS, P.O. BOX 935, MONROE, CT, 06468, US

(21) Appl. No.: 11/766,753

(22) Filed: Jun. 21, 2007

(51) Int. Cl. G05D 23/00; G05D 22/00; G05D 23/19

(52) U.S. Cl. 236/46 C; 236/94

(57) ABSTRACT

An integrated controller for controlling a vapor compression based heating and cooling system. The integrated controller includes modules for independently controlling dry bulb temperature, humidity level, and incorporating a fault detection module therewith. The fault detection module being capable of detecting abnormal refrigerant levels using only temperature sensors on the condenser with thermal expansion valve or evaporator with fixed orifice type of expansion valve.

### FIELD OF THE INVENTION

The invention relates to controlling vapor compression based heating and cooling systems. More specifically, it relates to a method and an apparatus for independently controlling both temperature and humidity and having an integrated fault detection module for use with a vapor compression based heating and cooling system.

### BACKGROUND OF THE INVENTION

A vapor compression cycle based refrigeration system is commonly used as an air-conditioner or a heat pump for cooling or heating an interior building space. Typically, in the operation of a fixed speed (or constant-volume) air-conditioning system, a thermostat senses and compares the room air dry-bulb temperature to a variable set-point temperature and turns on or turns off the heating and air-conditioning system. When the system is running, air passing through an evaporator coil located in an air-handler is cooled. If the air is cooled below its dew point temperature, moisture condenses on the evaporator coil and dehumidification occurs. Therefore, in a conventional thermostatic controller, room air dry-bulb temperature is used to control space dry bulb temperature. Humidity control is only a byproduct and is not actively controlled. At a partial load (low sensible load) condition with a high humidity, the system run time is low and the desired humidity level cannot be achieved.

Faulty operation of an air-conditioning system results in increased energy use and causes uncomfortable conditions. While there are different fault conditions associated with air-conditioning systems, there are two main fault conditions—airflow volume fault and incorrect refrigerant charge. If airflow is too high, room air will not be dehumidified properly. On the other hand, if air flow is too low, the room cannot be cooled properly and results in increased energy use. Also, very low air flows can freeze the indoor evaporator coils. Studies have shown that significant airflow problems exist. Seven studies that had sufficient data suggested that seventy percent of all homes had airflow twenty percent below the recommended levels. This translates into a loss of ten percent efficiency for the most common types of central air-conditioners.

Correct refrigerant charge is very important for proper operation of an air-conditioner. Refrigerant overcharging can cause flooding, slugging, and premature compressor failure. Undercharge will prevent adequate cooling. While overcharging results in slight loss in energy efficiency, undercharging can result in significant reduction in energy efficiency. Therefore, it is critical that all of the above identified problems be diagnosed and resolved to achieve energy savings.

Both indoor air temperature and relative humidity affect an occupant's comfort. In some systems, a separate dehumidification system is integrated with an air-conditioning system to control humidity and offer improved comfort. U.S. Pat. No. 5,915,473, issued to Ganesh et al., relates to an integrated humidity and temperature controller for an air-conditioning system with an integrated dehumidifier. Instead of controlling relative humidity, indoor temperature set-point can be varied to maintain comfort conditions.

U.S. Pat. No. 6,843,068, issued to Wacker, teaches a method to adjust the set-point temperature based on humidity level for maintaining comfort. It is also known to control humidity by controlling air-flow over an indoor coil. In U.S. Pat. No. 4,003,729, issued to McGrath, an air-conditioning system with improved dehumidification is proposed. In order to achieve increased dehumidification, airflow over the evaporator coil is reduced. Air flow is varied according to monitored evaporator temperature and a desired refrigerant temperature in the evaporator is maintained at a predetermined level. In U.S. Pat. No. 5,062,276, issued to Dudley, an air-conditioner with a variable speed fan and a variable speed compressor are used to improve humidity control. The fan speed is varied generally linearly with the compressor speed set as a function of cooling demand. When the humidity is more than the set-point (humidistat), the minimum compressor speed is increased, while the minimum fan speed remains the same. U.S. Pat. No. 5,303,561, issued to Bahel, relates to a microprocessor based air-conditioning control system for optimum efficiency. The fan speed is controlled based on humidity measurement, to reduce airflow when humidity is high. U.S. Pat. No. 6,070,110, issued to Shah, et al. discloses a thermostat control that includes a temperature sensor and a humidity sensor and a process to control the indoor air fan in response to indoor temperature and humidity conditions.

A simple method for detecting faults in a residential HVAC system has just two temperature sensors measuring supply and return air temperatures. The controller sends an alarm if the temperatures and the temperature difference deviate from reference values. It doesn't provide information on refrigerant charge or airflow. A hand-held fault detection and diagnostic system for field service technicians is also known. Another method related to HVAC system fault detection is a device that monitors several temperatures and the differential pressure across an air filter to detect certain faults and alerts a service contractor. Measured temperatures include outdoor air temperature, return air temperature, liquid line temperature, suction line temperature and fan motor temperature. U. S. Pat. Nos. 6,324,854 and 6,658,373, issued to Jayanth and Rossi, et al. respectively, each describe HVAC system fault detection using a hand-held computer requiring service technicians to operate.

U.S. Pat. No. 5,628,201, issued to Bahel et al., discloses an overcharge-undercharge diagnostic system for air-conditioner control. This method uses the compressor discharge temperature measured at a predetermined expansion valve setting and compares it with a reference discharge temperature. If the measured temperature is higher than the reference, the system is undercharged and if the measured temperature is lower than the reference, the system is overcharged. U.S. Pat. No. 5,381,669, also issued to Bahel, discloses a concept of integrating charge fault detection into an air-conditioner controller. U.S. Pat. No. 5,586,445, issued to Bessler, discloses a system to detect low refrigerant charge by monitoring the compressor discharge pressure and temperature. A controller receives sensor output signals and produces a low charge signal whenever a combination of a high discharge temperature and a low discharge pressure is detected.

U.S. Pat. No. 5,860,286, issued to Tulpule, discloses a refrigerant monitoring system with neural networks. First, the neural network is trained to learn the characteristics of the system. Then, the trained network timely computes refrigerant charge during a runtime mode of operation. The variance data is made available. U.S. Pat. No. 5,987,903 issued to Bathla, describes a method to detect refrigerant charge level by measuring pressure and temperature at the condenser outlet. The detection here determines actual sub cooling and compares it with a reference sub cooling to arrive at the charge condition. U.S. Pat. No. 6,981,384 issued to Dobmeier et al. describes using mid coil temperature for condenser saturation and sub-cooled liquid temperature in the liquid line to estimate refrigerant levels in a system.

This approach to the determination of refrigerant charge level is well known. Typically, refrigerant sub-cooling in the condenser is employed for determining charge level. Refrigerant sub-cooling is the difference in refrigerant saturation temperature and the refrigerant temperature at the condenser outlet, which is lower than the saturation temperature and thus is sub-cooled. Refrigerant saturation temperature is obtained from saturation pressure-temperature relationship by measuring the refrigerant pressure at the condenser outlet or the liquid line in the refrigeration cycle. The present invention does not utilize a pressure sensor but only a temperature sensor to measure the saturation temperature directly. As described above U.S. Pat. No. 6,981,384 uses saturation temperature as measured at approximately the mid coil (or loop) of the condenser, which may be a two-phase region. However, it is experimentally determined that one or two coils above the mid coil may assure two-phase region for measuring saturation temperature in the condenser. The difference in the saturation temperature and the condenser outlet temperature is the measured condenser sub-cooling. Since it is not the same as the one obtained from the measured saturation pressure, it is referred to as equivalent sub-cooling. This equivalent sub-cooling is a direct function of the refrigerant charge level in the system. Thus a fault detection module can utilize these simple inputs to determine refrigerant level in the vapor compression system.

### SUMMARY OF THE INVENTION

According to the present invention, an integrated controller performs the functions of a thermostat and a humidistat with a fault detection module incorporating only temperature sensors for fault detection. The control portion of the integrated controller includes modules to control both temperature and humidity in a conditioned space to maintain comfort conditions and eliminate conditions that promote growth of mold and mildew. The controller reads the indoor air temperature and relative humidity and compares them with the temperature and relative humidity set points as set by a user to enable normal cooling mode or dehumidification mode.

In a preferred embodiment, in one dehumidification mode, where there is a multiple or variable speed fan, the fan speed is reduced from nominal speed by thirty percent or greater. Typically, indoor airflow of 400 to 450 cubic feet per minute per ton (cfm/ton) of cooling is used. In the dehumidification mode, air flow can be reduced up to 250 cfm/ton. However, precaution must be taken so that the evaporator coil does not freeze due to very low airflow, which reduces the evaporator temperature.

National standards for indoor air quality recommend an indoor relative humidity below sixty percent for comfort and health. Therefore, in a preferred embodiment of the present invention a default maximum set-point of sixty percent for relative humidity in cooling is used, which can be reprogrammed should the need arise. When a user selects a relative humidity set-point greater than sixty percent, the set-point will be forced to the default maximum relative humidity. Similarly, the preferred embodiment incorporates a default low, or minimum, relative humidity. In this case, when a user selects a relative humidity less than the default minimum, the controller will be defaulted to the minimum relative humidity, which can also be reprogrammed. In another embodiment, in a dehumidification mode, when the air-conditioning system has a multiple or variable speed compressor along with a multiple or variable speed indoor fan, the indoor airflow is reduced to its minimum while the compressor operates at a speed suitable for the sensible heat load.

In another preferred embodiment, the integrated controller can detect a low refrigerant charge condition, an over charge condition, and an airflow fault condition. The fault detection module incorporates an indoor air temperature sensor, an outdoor air temperature sensor, indoor relative humidity sensor, supply duct air temperature and return duct air temperature. In addition, this embodiment includes a pair of temperature sensors that measure the liquid refrigerant equivalent sub-cooling for an air-conditioner with a thermostatic expansion valve and the equivalent evaporator superheat for an air-conditioner with a fixed orifice type expansion device. The amount of measured sub-cooling or superheat indicates whether the air-conditioning system is under charged or over charged or normal. The integrated control module calculates the difference in measured return air temperature and supply air temperature and compares it with a pre-determined value to establish whether the system air flow is normal, low or high. When the controller encounters a refrigerant charge fault or airflow fault, fault conditions are displayed on the controller or remotely.

### BRIEF DESCRIPTION OF THE DRAWINGS

FIG. 1 is a schematic of a vapor compression based air-conditioning system;

FIG. 2 is a diagram illustrating inputs and outputs of an integrated controller for an air-conditioning system with a thermostatic expansion device (TXV);

FIG. 3 is a diagram illustrating an integrated controller for an air-conditioning system with a fixed orifice expansion device;

FIG. 4 is a flowchart of an integrated controller;

FIG. 5 is a flowchart showing a fault detection module of the integrated controller for a system with a TXV expansion device; and

FIG. 6 is a flowchart of a fault detection module of the integrated controller for a system with a fixed orifice expansion device.

### DETAILED DESCRIPTION OF THE PREFERRED EMBODIMENT

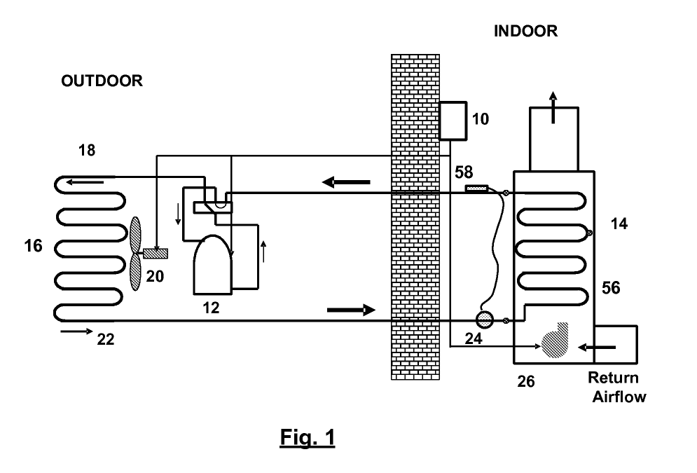

Referring to FIG. 1, an integrated controller 10 combines the functions of a thermostat, a humidistat and automated fault detection into one device is shown schematically in combination with a vapor compression based air-conditioning system. As shown in FIG. 1, the vapor compression system includes a compressor 12, for compressing a low-pressure refrigerant vapor exiting an evaporator coil 14 into a high pressure and temperature vapor. This high pressure vapor refrigerant rejects heat to outdoor ambient air 16 in a condenser 18 condensing into a liquid. An outdoor fan 20 blows ambient air 16 across the coils and fins of condenser 18.

The liquid refrigerant temperature at the condenser outlet 22 is generally lower than the saturation temperature of the refrigerant at that location. This difference in temperature is called as condenser sub-cooling, which is a good indicator of the level of refrigerant charge within the system. In the present invention, it is preferred that a temperature sensor is placed at least one or two coils (loops) above the mid coil of the condenser to measure the refrigerant saturation temperature. Refrigerant temperature at the outlet of the condenser is also measured. The liquid refrigerant then passes through an expansion device 24 such as a thermostatic expansion valve (TXV) or a fixed orifice device and becomes a low pressure two-phase refrigerant. This refrigerant then enters the indoor evaporator coil 14 and absorbs heat from the indoor air circulated by an indoor fan 26. Thus indoor air is cooled by the refrigerant in the vapor compression cycle. The refrigerant leaving evaporator 14 at an evaporator outlet 28 is generally at a higher temperature than that of its saturation temperature and this difference is known as evaporator superheat, which is also a good indicator of refrigerant charge level. The refrigerant vapor then enters the compressor 12 and the cycle repeats. In effect, indoor air is cooled by absorbing heat from indoor air and rejecting the heat to outdoor air in a vapor compression based air-conditioning system.

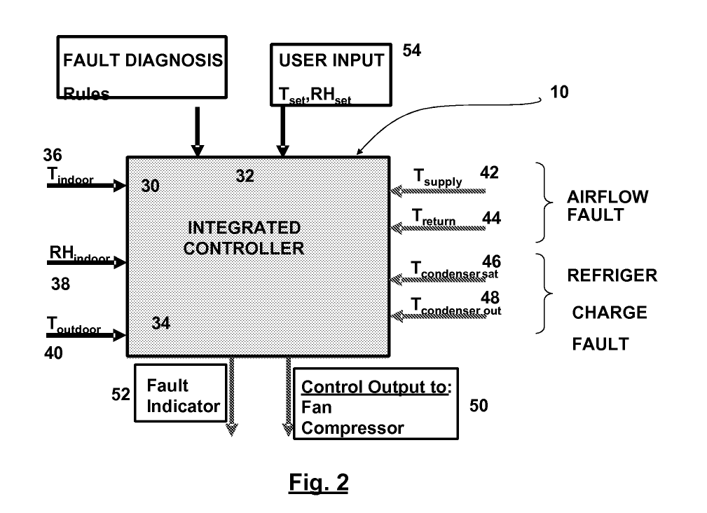

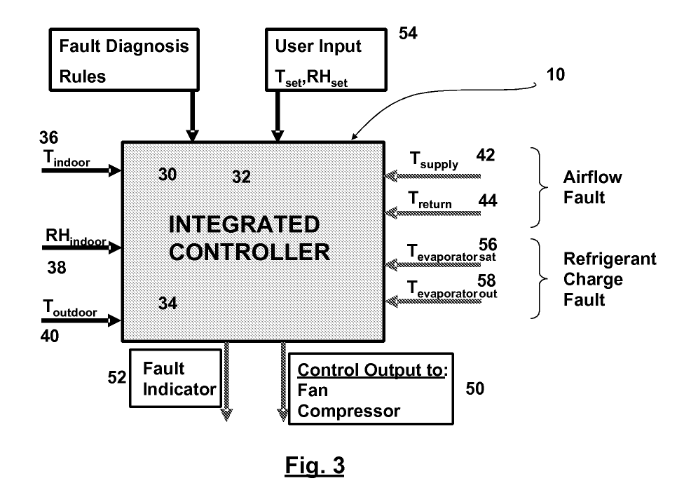

In a conventional system, a thermostat controls the air-conditioning system using dry bulb temperature alone. As shown in FIG. 2, a thermostat 30 is one module of an integrated controller 10. Integrated Controller 10 also includes a humidistat module 32 and a fault detection module 34. As shown in FIG. 2, controller 10 is microprocessor based and has sensor inputs for indoor air dry-bulb temperature 36, indoor relative humidity 38, outdoor air temperature 40, supply air temperature 42, return air temperature 44, equivalent liquid refrigerant saturation temperature 46, and condenser outlet temperature 48 as measured at condenser liquid outlet 22. Outputs include control signals 50 to compressor 12 and outdoor (condenser) fan 20, and indoor fan 26. A fault indicator 52 such as an LED/LCD display is activated by fault detection module 34 as described herein. Fault detection module 34 incorporates rules that are predetermined ranges for refrigerant sub-cooling or superheat to detect refrigerant fault, and ranges for temperature difference between the return air temperature 44 and supply air temperature 42 for determining airflow fault. Selectable inputs 54 are indoor temperature set-point, relative humidity set-point and occupancy schedule (time of day). The embodiment shown in FIG. 2 is applicable for an air-conditioning system with a thermostatic expansion device (TXV) or a fixed orifice but is preferably used for a system with TXV. FIG. 3, as described further below, shows an integrated controller preferably used with an expansion device 24 of the fixed orifice type, which uses evaporator saturated temperature 56 and evaporator outlet temperature 58 to evaluate refrigerant level of the system.

Referring to FIGS. 2 and 3, indoor airflow fault is detected by measuring the supply air temperature 42 and the return air temperature 44. Controller 10 detects a high airflow fault if the difference in return air temperature 44 and supply air temperature 42 is lower than a predetermined value and a low airflow fault if the difference is higher than a predetermined value. Since this temperature difference is a function of outdoor temperature 40, the predetermined values are specified at a specific outdoor temperature or specified as a function of outdoor temperature.

FIG. 3 shows a controller 10 more suitable for a system with a fixed orifice in detecting a refrigerant charge fault. For a system with fixed orifice type of expansion device 24, evaporator superheat, which is the difference between the evaporator outlet temperature 58 and the saturation temperature 56 at the evaporator outlet is used for determining the refrigerant charge level. Evaporator saturation temperature 56 is commonly obtained by measuring pressure at the service port (low side) and from the saturation pressure-temperature relationship. However, since the present invention uses only the temperature sensors, refrigerant temperature at the evaporator inlet, which corresponds to the saturation temperature 56 and refrigerant temperature at the evaporator outlet 58 are measured. The difference between these two temperatures is the evaporator superheat. The fault detection module 34 compares the measured evaporator superheat with predetermined values. If the measured superheat is greater than the predetermined value, then a low charge fault is detected. If the measured superheat is lower than the predetermined value, then an overcharge fault is detected. Refrigerant low charge fault detection can be undertaken at a specified outdoor temperature or as a function of outdoor temperature. Accordingly, fault detection module 34 may include threshold values for superheat as a function of outdoor temperature.

In a preferred embodiment the present invention incorporates temperature and humidity control with an automatic fault detection system, which has been discussed above. In addition, according to the present invention, supply air temperature 42 or evaporator temperature 56 is monitored to prevent indoor evaporator coil freezing.

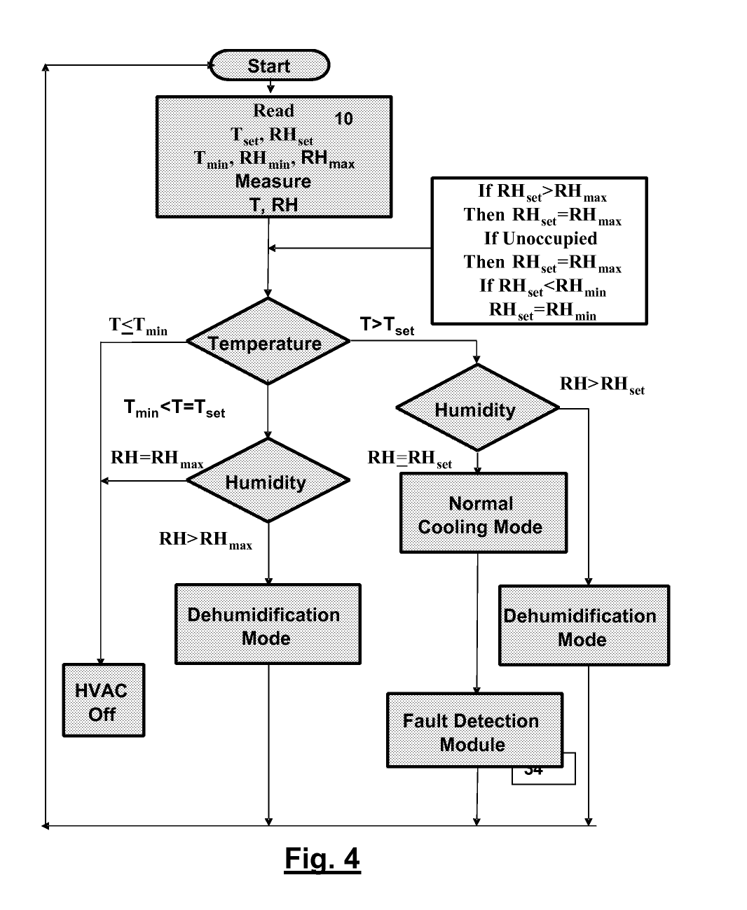

The operation of controller 10 is shown in FIG. 4. A user of the controller 10, in combination with a vapor compression based air-conditioning system, selects a temperature set-point (Tset) and a relative humidity set-point (RHset). The controller 10 operates the air-conditioning to maintain these temperatures. However, a typical user is accustomed to adjusting only a temperature setting on a thermostat and is not accustomed to adjusting the relative humidity setting. Therefore, to prevent improper settings, operational envelope (minimum and maximum) for relative humidity are enforced by the controller 10. Minimum indoor air temperature (Tmin), minimum indoor relative humidity (RHmin), and maximum indoor relative humidity (RHmax) are the defaults set at the factory, which can be reprogrammed with the aid of a user manual. These default settings prevent the improper operation of the air-conditioning system. When the sensed room air temperature (T) is higher than the temperature set-point (Tset), the controller 10 checks whether the relative humidity (RH) is above the relative humidity set-point (RHset). If RH is less than RHset, then the air-conditioning system operates in normal mode, i.e., normal indoor fan speed is implemented. Otherwise, the air-conditioning system is in dehumidification mode, where the indoor airflow (fan speed) is reduced such that the evaporator temperature is greater than a pre-determined value to prevent evaporator coil freezing. When the controller 10 is employed with an air-conditioning system with a TXV expansion device 24, an evaporator temperature sensor is utilized. However, since the controller 10 utilizes a supply air temperature sensor, which can be employed to infer the evaporator temperature, additional evaporator sensor is not required. When the controller 10 is employed with a system that has a fixed orifice expansion device 24 as in FIG. 3, it already has a temperature sensor that monitors evaporator temperature. This temperature sensor is used in controlling the fan speed to prevent evaporator coil freezing.

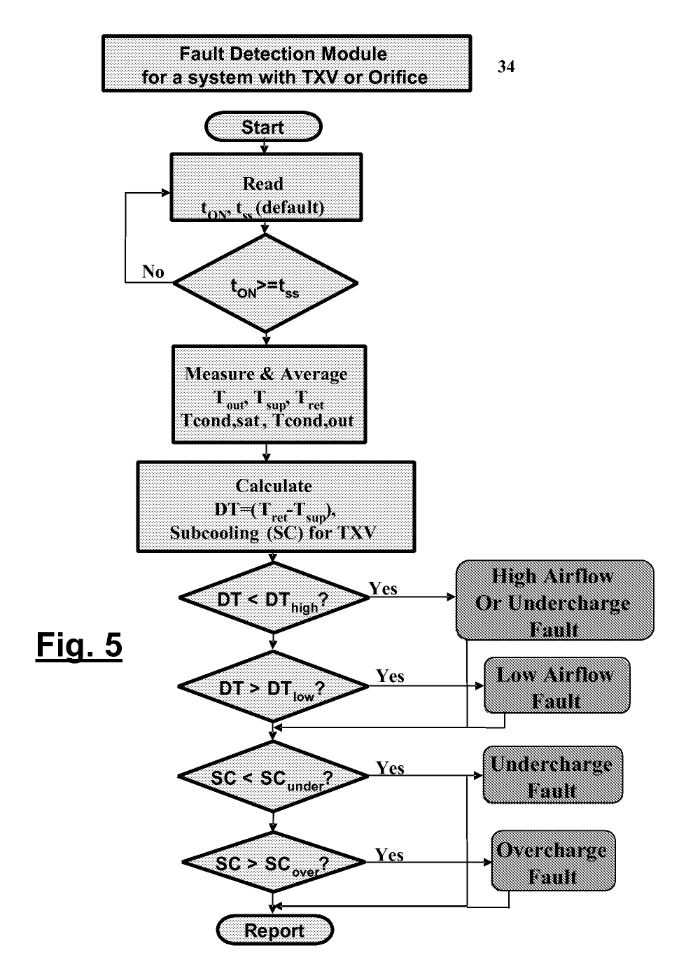

When the sensed air temperature is below Tset but higher than the minimum temperature (Tmin) and RH is higher than RHmax then the system is placed in dehumidification mode. Otherwise, the system is turned OFF. If the air temperature is below Tmin, the system remains turned off. When the system is turned ON in either normal cooling mode the fault detection module 34 is activated in the controller 10. The fault detection module 34 for a system with a TXV or fixed orifice is shown in FIG. 5. However, this module is preferred for a system with a TXV type of expansion device 24. As shown in FIG. 5, when the module is activated it reads the system on-time (t on) and compares with a pre-determined time (t ss), which represents the time it takes the measured variables to reach a quasi-steady state. When t on is greater than t ss, the module begins to measure and average the variables Tout, Tcond sat₁, Tcond out, Tsup, and Tret. When the system is turned OFF, the module computes the difference in return air temperature and supply air temperature (DT), and the equivalent sub-cooling (SC) and compares with the fault detection rules to airflow faults and refrigerant charge faults. As indicated in FIG. 5, if DT is less than the predetermined DThigh, the high airflow is detected. However, the high airflow fault could be the result of undercharge fault as well. If the undercharge fault is negative, then the high airflow fault is confirmed. Otherwise, high airflow fault and undercharge could simultaneously occur as well. When DT greater than DTlow, then the low airflow fault is detected. When the system is operating in dehumidification mode, it will be obviously operating at a lower fan speed and hence low airflow. That is why airflow fault is not diagnosed when the system is in dehumidification mode.

Again referring to FIG. 5, when the measured SC is less than SCunder, the module detects undercharge fault and when the measured SC is greater than SCover, the module detects refrigerant overcharge. When the system completes the fault detection process and identifies faults, it reports the faults. These faults are indicated on the display of the controller 10. Additionally, with a communicating feature, the device can communicate the report with a service contractor or the report can be accessed through the internet.

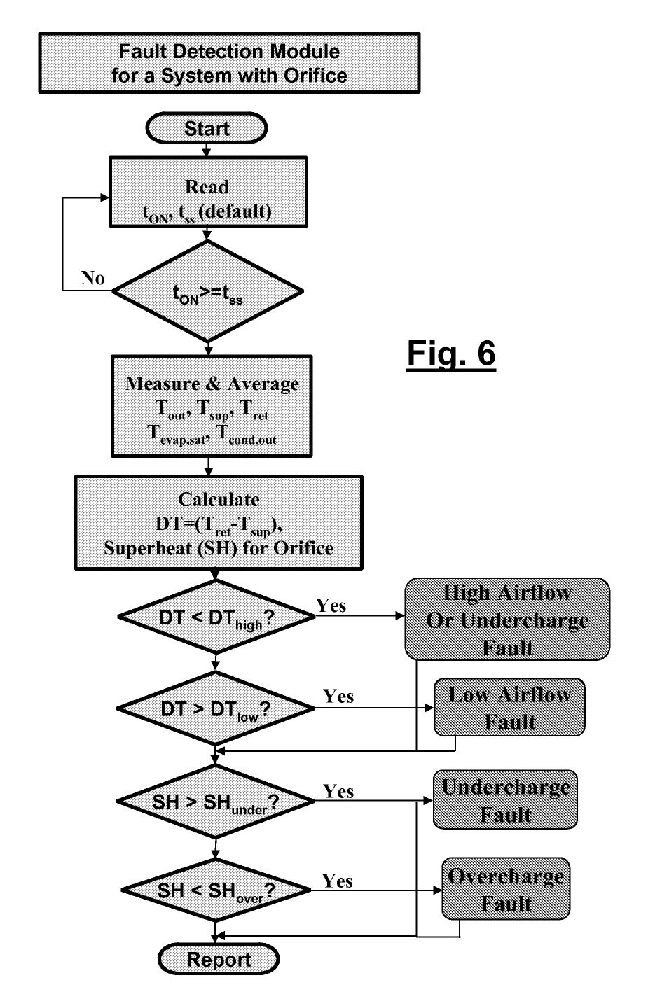

FIG. 6, shows the fault detection module for a system with a fixed orifice expansion device 24. The only difference from the module for a system with a TXV is that the sub-cooling measurement is replaced by the evaporator superheat, the difference between the evaporator outlet temperature and the evaporator inlet (saturation) temperature. As shown in FIG. 6, when SH is greater than SHunder, then an undercharge fault is detected. When the SH is less than SHover, an overcharge fault is detected.

Those skilled in the art will recognize that the present invention may be manifested in a variety of forms other than the specific embodiments described and contemplated herein. Accordingly, the scope of legal protection given to this invention can only be determined by studying the following claims.

What is claimed is:

1. An integrated controller for controlling a vapor compression based space conditioning system comprising: a thermostat module, a humidistat module and a fault diagnosis module.

2. The integrated controller of claim 1, wherein said thermostat module includes resetable minimum and maximum limits.

3. The integrated controller of claim 1, wherein said humidistat includes resetable minimum and maximum limits.

4. The integrated controller of claim 1, said fault diagnosis module having temperature sensors located to sense evaporator saturated temperature and condenser liquid outlet temperature.

5. The integrated controller of claim 4, wherein said evaporator saturated temperature is located one to two u-bends above the mid coil loop.

6. The integrated controller of claim 1, wherein said fault diagnosis module includes an air flow fault indicator and sensors place in the supply air stream and the return air flow stream.

7. An integrated controller for controlling temperature and humidity in an enclosed building space by controlling a typical heating and air-conditioning system; said integrated controller having a thermostat module with resetable minimum and maximum limits, a humidistat module with resetable minimum and maximum limits, a fault indication module having fault indicators for air-flow including temperature sensors in a supply air stream and a return air stream; and refrigerant levels and having sensors for sensing condenser saturated temperature and condenser liquid outlet temperature.

8. The integrated controller of claim 7, including a condenser saturated temperature sensor located one to two u-bends above a mid coil u-bend.

9. The integrated controller of claim 7, wherein said fault diagnosis module uses temperature sensors with an algorithm of pre-determined values alone to predict refrigerant level within said heating and air-conditioning system.

10. A method of controlling a dry bulb and wet bulb temperature within a building space including the steps of: sensing said dry bulb temperature; sensing said wet bulb temperature; comparing these sensed temperatures and controlling a heating and air-conditioning system for removing sensible heat load or latent heat load to the extant possible as required to maintain a comfortable level of each within said space.

11. The method of claim 10, including a method of detecting faults within said system and indicating on a display means what said fault is.

12. The method of claim 11, further including the step of detecting an air flow fault within said by sensing a temperature in a return air flow stream and sensing a temperature in a supply air stream and comparing those values to a pre-determined range of values to evaluate total air flow within the system.

13. The method of claim 11, further including the step of detecting refrigerant levels with said system by sensing condenser saturated temperature and sensing condenser liquid line out temperature and comparing the sensed temperature difference to a pre-determined value to evaluate refrigerant level with said system and displaying on a display means a fault indication if the refrigerant level varies from a normal amount.

14. The method of claim 11, further including the step of detecting refrigerant levels with said system by sensing evaporator saturated temperature and sensing evaporator liquid line out temperature and comparing the sensed temperature difference to a pre-determined value to evaluate refrigerant level with said system and displaying on a display means a fault indication if the refrigerant level varies from a normal amount.

15. The method of claim 10, including operating said heating and air-conditioning system in a dehumidification mode by controlling an indoor fan to lower a system air flow rate resulting in a lower evaporator temperature, and sensing said evaporator temperature lower than a predetermined value said controller increases said air flow to prevent evaporator freeze up.
